(19) United States
(12) Patent Application Publication
(10) Pub. No.: US 2009/0319374 A1
(43) Pub. Date: Dec. 24, 2009

(54) DISTRIBUTED AD-SELECTION SYSTEM AND METHOD FOR DISTRIBUTED AD SELECTION

(75) Inventors: Michal Andrzej Rybak, Upper Mount Standfast (BB); Gaelle Christine Martin-Cocher, Toronto (CA)

Correspondence Address: Research in Motion Corp/SLW;Attn: Glenda Wolfe, Building 6, Brazos East, Suite 100, 5000 Riverside Drive, Irving, TX, 75039, US

(73) Assignee: Research In Motion Limited, Waterloo (CA)

(21) Appl. No.: 12/479,367

(22) Filed: Jun. 5, 2009

Related U.S. Application Data
(60) Provisional application No. 61/059,525, filed on Jun. 6, 2008.

(51) Int. Cl. G06Q 30/00

(52) U.S. Cl. 705/14.58; 705/14.64; 705/14.4

(57) ABSTRACT

Embodiments of a distributed ad-selection system and method for distributed ad selection are generally described herein. In some embodiments, an applications service provider sends a query to an advertising service provider for ads. The query includes ad-selection criteria and an indication to indicate whether broadening of the criteria is permitted. The ads are received and cached by the application service provider including associated relevancy information. Cached ads are selected by the applications service provider for distribution to mobile devices based on the relevancy information and based on applications operating on the mobile devices that are being serviced by the applications service provider.

### CROSS-REFERENCE TO RELATED APPLICATION

This non-provisional patent application claims the benefit of the filing date of U.S. Provisional Patent Application Ser. No. 61/059,525; filed Jun. 6, 2008; and entitled, “DISTRIBUTED AD-SELECTION SYSTEM AND METHODS FOR DISTRIBUTED AD SELECTION,” the content of which is incorporated by reference herein.

### TECHNICAL FIELD

Some embodiments pertain to the selection of advertisements (ads) for presentation to users of mobile devices. Some embodiments pertain to systems and devices that operate in accordance with one or more of the Open Mobile Alliance (OMA) standards or specifications. Some embodiments pertain to wireless networks and wireless communications.

### BACKGROUND

In conventional networks, one entity generally selects advertisements to present to users. This entity is generally the entity that has a relationship with advertisers, such as an advertising service provider or a network service provider that operates the network. Application service providers, on the other hand, which operate and service applications that operate on mobile devices, are generally not involved with ad selection and presentation. The application service providers are generally not able to inject or associate ads into/with applications or content at the most relevant context (place, time) due to technical and/or contractual restrictions by the network service provider and/or the advertising service provider. As a result, some advertising use cases may not be satisfied.

### BRIEF DESCRIPTION OF THE DRAWINGS

FIG. 1 illustrates a distributed ad-selection system in accordance with some embodiments; and

FIG. 2 is a flow chart of a procedure for distributed ad selection in accordance with some embodiments.

### DETAILED DESCRIPTION

The following description and the drawings provide various embodiments. Other embodiments may incorporate structural, logical, electrical, process, and other changes. Examples merely typify possible variations. Individual components and functions are optional unless explicitly required, and the sequence of operations may vary. Portions and features of some embodiments may be included in, or substituted for those of other embodiments.

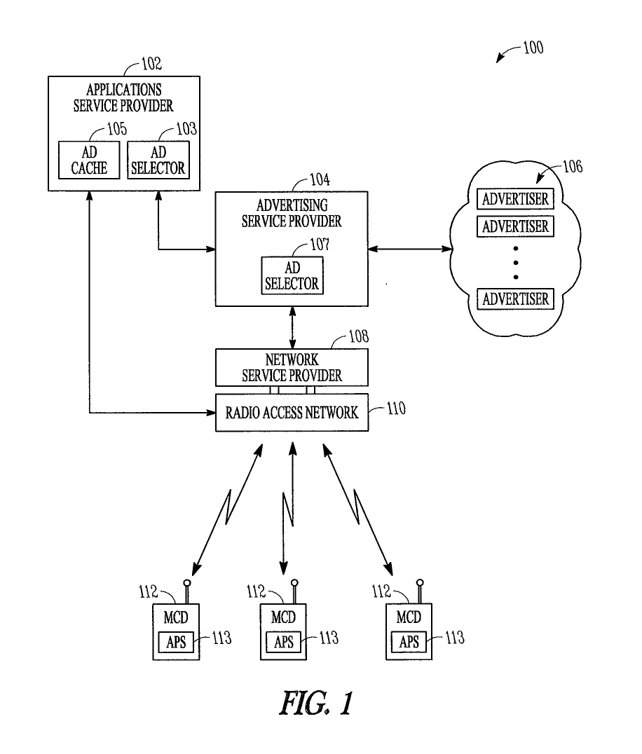

FIG. 1 illustrates a distributed ad-selection system in accordance with some embodiments. Distributed ad-selection system 100 includes applications service provider 102, advertising service provider 104, a plurality of advertisers 106, network service provider 108, and radio access network 110. Mobile communication devices (MCDs) 112 may communicate using one or more wireless communication techniques through radio access network 110, which may include one or more base stations or access points. Network service provider 108 may provide the wireless service for mobile devices 112 through radio access network 110. The wireless service may include all types of mobile communication services including mobile telephone service and network services such as internet access.

Advertising service provider 104 may operate with network service provider 108 to provide advertisements (ads) selected from advertisers 106 to mobile devices 112 when, for example, network services are provided. In some embodiments, advertising service provider 104 and network service provider 108 comprise a single entity, while in other embodiments, advertising service provider 104 and network service provider 108 are independent entities. When independent entities, the connection between advertising service provider 104 and network service provider 108 may be optional.

Applications service provider 102 may service and operate applications 113 that run on mobile devices 112. In some embodiments, applications service provider 102, mobile devices 112 and/or advertising service provider 104 may service and operate applications in accordance with one or more of the standards or specifications of the OMA, such as the OMA mobile advertising standard. Examples of applications 113 that may be serviced and operated by applications service provider 102 may include multimedia content delivery applications, email applications, calendar applications, and scheduling applications, although other applications may also be serviced and operated.

In accordance with embodiments, applications service provider 102 may send a query to advertising service provider 104 for ads. The query may include ad-selection criterion or criteria, and an indication of whether broadening of the criterion or criteria is permitted. In some embodiments the query may include multiple sets of ad selection criteria, each set corresponding to a different context (user context, contexts related to different content items). For example the application service provider may present 10 news items on a page. The query may provide a request for two advertisements, and 10 sets of criteria; each set corresponding to each news item. The returned two advertisements may be associated with the news item to which the advertisements correspond. Applications service provider 102 may receive and cache the ads provided by advertising service provider 104. Associated relevancy information received from advertising service provider 104 may also be cached. In some embodiments, the associated relevancy information may indicate to which set or sets of ad-selection criteria the associated relevancy information corresponds. Applications service provider 102 may select some of the received ads for distribution to mobile devices 112 based on the relevancy information and based on applications 113 operating on mobile devices 112 being serviced by applications service provider 102 and used to present the advertisement. In some embodiments, applications service provider 102 may select ads for distribution to mobile devices 112 based on additional information that includes user location and analysis of user content present in mobile devices 112. For example, the user content that may be analyzed may include information pertaining to the content the user accesses or information discussed (e.g., if the user talks about red sports cars with this friends), user contact information (e.g., whether the user has predominantly male or female contacts in an address book), etc.

In some embodiments, applications service provider 102 may include ad selector 103 to send the query to an advertising service provider 104 for ads, and ad cache 105 to receive and to cache the ads provided by advertising service provider 104 including the associated relevancy information. Ad selector 103 may additionally select the cached ads for distribution to mobile devices 112. In some embodiments, advertising service provider 104 may include ad selector 107. Although not shown in FIG. 1, the ad selector may be additionally or alternatively located or otherwise configured on a component of the mobile device 112 or embedded within an application on the mobile device 112 such that the component or application distributes selected ads to applications (e.g., application 113) on the device 112 presenting ads. Ad selector 107 may work in combination or cooperation with ad selector 103 to narrow-down the more appropriate ads. In embodiments when advertising service provider 104 and network service provider 108 operate together, ad selector 107 may also select ads for services provided by network service provider 108.

In some embodiments, ad cache 105 is optional. In these embodiments, the selection of ads or the insertion of ads in association with a given content or in a given display area by applications service provider 102 for distribution to mobile devices 112 may happen immediately after ads are received from advertising service provider 104. In these embodiments, selection may happen based on user-specific selection criteria, which may include the types of applications the user has installed on the mobile device as well as current and historical user preference context information derived by an analysis of the user's content (e.g., analysis of email content) and behavior (e.g., analysis of a user's past and present geographical locations).

In some embodiments, the received ads are selected and distributed by applications service provider 102 based on the ad-selection criterion, criteria or sets of ad-selection criteria that was met or the ad-selection criterion, criteria or sets of ad-selection criteria that was not met. In some embodiments, the relevancy information includes a relevancy index, and applications service provider 102 selects and distributes the received ads based, at least in part, on the relevancy index. In some embodiments, when distributing the received ads, applications service provider 102 may inject selected ads into applications 113 operating on mobile devices 112 that are being serviced by applications service provider 102. In these embodiments, the received ads may be further selected based on the location of a mobile device 112 and an analysis of user content present in a mobile device 112.

Unlike conventional systems, the relevancy information provided by advertising service provider 104 is used for ad selection or ad positioning by another downstream entity, such as applications service provider 102. In this way, applications service provider 102 or another downstream entity may make its own decisions regarding distribution or positioning of ads with content to users depending on what the provider/entity believes a user is going to respond to.

In some embodiments, radio access network 110 may operate in accordance with the IEEE 802.16(e) standard (e.g., WiMax), one of the 802.11 WLAN standards, one of the LTE (4G) standards, one of the 3G standards, or another wireless or mobile communication standard. Mobile devices 112 may be configured as various wireless communication devices including wireless portable and hand-held devices. Mobile devices 112 also include Blackberry or smartphone-type devices that operate various applications thereon. Although distributed ad-selection system 100 is illustrated as having several separate functional elements, one or more of the functional elements may be combined and may be implemented by combinations of software-configured elements, such as processing elements including microprocessors, microcontrollers, digital signal processors (DSPs), and/or other hardware elements. For example, ad selector 103 and ad cache 105 may comprise one or more microprocessors, DSPs, application specific integrated circuits (ASICs), radio-frequency integrated circuits (RFICs) and combinations of various hardware and logic circuitry for performing at least the functions described herein.

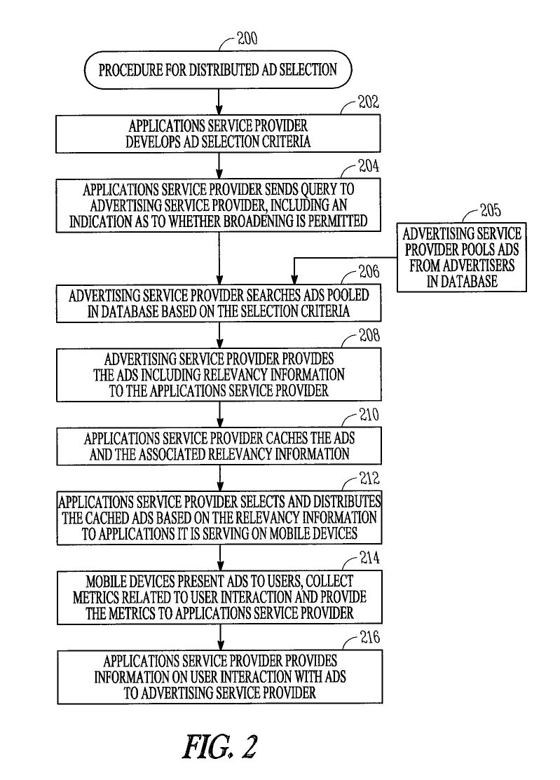

FIG. 2 is a flow chart of a procedure for distributed ad selection in accordance with some embodiments. Procedure 200 may be performed by various elements of distributed ad-selection system 100 (FIG. 1), although other systems may be used to perform procedure 200. Referring to FIGS. 1 and 2 together, in operation 202, applications service provider 102 develops an ad-selection criteria. Operation 202 may be performed by ad selector 103 of applications service provider 102.

In operation 204, applications service provider 102 sends a query to advertising service provider 104. The query includes an ad-selection criterion, criteria or sets of ad-selection criteria. Furthermore, as shown, operation 204 may include sending an indication of whether broadening of the criterion, criteria or sets of ad selection criteria is permitted. The query may be constructed in a way to allow the sending of multiple sets of ad-selection criteria. In some embodiments, a binary flag may be used in the request or query to indicate whether broadening is permitted.

In operation 205, ads, provided by advertisers 106, are pooled by advertising service provider 104. The pooled ads may include metadata and other information including relevancy information. Operation 205 may be performed by advertising service provider 104 to pools ads independent of the operations performed by applications service provider 102, and may be performed prior to receipt of the query sent in operation 204. Accordingly, advertising service provider 104 may have a database of pooled ads available.

In operation 206, advertising service provider 104 may search the ads pooled in its database based on the ad-selection criteria and, in some instances, based on whether or not broadening is permitted. When broadening is not permitted, only ads meeting the ad-selection criterion or criteria are selected from the database. Ads identified by advertising service provider 104 including relevancy information are provided to applications service provider 102.

In operation 208, applications service provider 102 receives the ads including relevancy information provided by advertising service provider 104. The relevancy information may include an indication of any ad-selection criterion, criteria or sets of ad-selection criteria that was met, or an indication of the ad-selection criterion, criteria or sets of ad-selection criteria that was not met. In some embodiments, the relevancy information may include a relevancy index based on a percentage of the ad-selection criteria or sets of ad selection criteria that was met. In some embodiments, the relevancy index may be the ratio of met to unmet criteria or sets and may be expressed as a percentage.

In operation 210, applications service provider 102 caches the received ads and the relevancy information in ad cache 105. The caching of ads and the associated relevancy information may be optional.

In operation 212, applications service provider 102 selects and distributes the received ads, or a subset of the received ads, based on the relevancy information and other information to applications 113 operating on mobile devices 112. The ads may be selected based on information related to a specific application 113 being operated by mobile devices 112, as well as other information that may be specific to the user. In some embodiments, at least one subset of the received ads may be selected based on the relevancy information and may be distributed to an application configured to present ads on a mobile device. In further embodiments, at least one subset of the received ads may be associated with content when distributed to an application. In some embodiments, the ads may be distributed directly from applications service provider 102 through radio access network 110 to mobile devices 112. In some embodiments, the ads may be distributed directly from applications service provider 102 through radio access network 110 using one or more techniques optimized for mobile communications and specific to the particular application that is being run. For example, a UDP type of protocol may be used, rather than an HTTP and TCP/IP type of protocol that is conventionally used for communication of advertisements. These techniques optimized for mobile communications may provide increased battery life through more efficient communications. For example, the number of packets may be reduced and/or the information may be compressed more efficiently.

In operation 214, mobile devices 112 may present the ads to users, may collect metrics related to user interaction with the ads, and may provide the metrics to applications service provider 102. The metrics related to user interaction with the ads may, for example, include ad consumption metrics, ad impression metrics, ad interaction metrics, and click-through-rate (CTR) metrics.

In operation 216, applications service provider 102 may provide metrics related to user interaction with the ads to advertising service provider 104. This information may be used by applications service provider 102 and advertising service provider 104 in many ways and may help facilitate, among other things, revenue sharing from the ads, although the scope of the embodiments is not limited in this respect.

In some alternative embodiments, additional or different elements of the distributed ad-selection system 100 (FIG. 1) may perform the procedure 200 described by reference to FIG. 2. For example, some or all of the operations identified in FIG. 2 as being performed by the applications service provided 102 may instead be performed by the mobile device 112.

Unless specifically stated otherwise, terms such as processing, computing, calculating, determining, displaying, or the like, may refer to an action and/or process of one or more processing or computing systems or similar devices that may manipulate and transform data represented as physical (e.g., electronic) quantities within a processing system's registers and memory into other data similarly represented as physical quantities within the processing system's registers or memories, or other such information storage, transmission or display devices. Furthermore, as used herein, a computing device includes one or more processing elements coupled with computer-readable memory that may be volatile or non-volatile memory or a combination thereof.

Embodiments may be implemented in one or a combination of hardware, firmware and software. Embodiments may also be implemented as instructions stored on a computer-readable medium, which may be read and executed by at least one processor to perform the operations described herein. A computer-readable medium may include any mechanism for storing or transmitting information in a form readable by a machine (e.g., a computer). For example, a computer-readable medium may include read-only memory (ROM), random-access memory (RAM), magnetic disk storage media, optical storage media, flash-memory devices, and others.

What is claimed is:

1. A method for selecting ads, the method comprising:
sending a query to an advertising service provider for ads, the query comprising at least one ad-selection criterion;
receiving ads in response to the query, received ads including associated relevancy information;
selecting at least one subset of the received ads based on the associated relevancy information; and
distributing the at least one subset of the received ads to an application configured to present ads on a mobile device.

2. The method of claim 1 wherein the query further comprises at least one set of ad-selection criteria.

3. The method of claim 1 wherein the method is performed by an applications service provider.

4. The method of claim 1 wherein the method is performed by a mobile device.

5. The method of claim 1 further comprising caching the received ads including associated relevancy information.

6. The method of claim 1 wherein the associated relevancy information comprises an indication of the at least one ad-selection criterion that was met or was not met.

7. The method of claim 6 wherein the received ads are selected based on the at least one ad-selection criterion that was met or the at least one ad-selection criterion that was not met.

8. The method of claim 1 wherein the associated relevancy information comprises a relevancy index.

9. The method of claim 8, wherein selecting and distributing the received ads is based, at least in part, on the relevancy index.

10. The method of claim 1, wherein distributing comprises associating the at least one subset of the received ads with a content.

11. The method of claim 1 wherein the at least one subset of the received ads is further defined based on additional information including at least one of a location of the mobile device and an analysis of user content present in the mobile device.

12. A computer-readable storage medium, with instructions stored thereon, which when executed by a processor perform the method of claim 1.

13. A mobile device comprising:
a processor;
a memory to store instructions, the instructions when executed cause the pocessor to:
send a query to an advertising service provider for ads, the query comprising at least one ad-selection criterion;
receive ads in response to the query, received ads including associated relevancy information; and
select at least one subset of the received ads based on the associated relevancy information.

14. The mobile device of claim 13 further comprising instructions to cache the received ads including the associated relevancy information.

15. The mobile device of claim 13 further comprising instructions to distribute the at least one subset of the received ads to an application configured to present ads on the mobile device.

16. The mobile device of claim 15 wherein the instructions to distribute further comprise instructions to inject selected ads into the application configured to present ads on the mobile device.

17. The mobile device of claim 13 wherein the associated relevancy information comprises an indication of the at least one ad-selection criterion that was met or was not met.

18. The mobile device of claim 13 wherein the received ads are selected based on the at least one ad-selection criterion that was met or the at least one ad-selection criterion that was not met.

19. The mobile device of claim 13 wherein the associated relevancy information comprises a relevancy index.

20. The mobile device of claim 19, wherein the mobile device selects and distributes the received ads based, at least in part, on the relevancy index.

21. The mobile device of claim 13 wherein the instructions to select comprise further instructions to select based on a location of the mobile device and an analysis of user content present in the mobile device.

22. An applications service provider comprising:
an ad selector to send a query to an advertising service provider for ads, the query comprising at least one ad-selection criterion; and
an ad cache to receive and cache ads in response to the query, received ads including associated relevancy information.

23. The applications service provider of claim 22 wherein the ad selector additionally selects at least one subset of the received ads from the ad cache for distribution to at least one mobile device based on the associated relevancy information and based on applications operating on the at least one mobile device being serviced by the applications service provider.

24. The applications service provider of claim 23 wherein when distributing the received ads, the applications service provider injects selected ads into the applications operating on the mobile devices and being serviced by the applications service provider, and
wherein the ad selector further selects the at least one subset of the received ads based on additional information including at least one of a location of a mobile device and an analysis of user content present in the mobile device.

25. A method for providing ads, the method comprising:
receiving a query for ads, the query having at least one ad-selection criterion;
identifying ads that correspond to the at least one ad selection criterion; and
returning at least the corresponding ads including associated relevancy information.
